(19) United States
(12) Patent Application Publication
(10) Pub. No.: US 2014/0152574 A1
(43) Pub. Date: Jun. 5, 2014

(54) Zig Zag Keyboard

(71) Applicant: Ahmet Akkok, Istanbul (TR)

(72) Inventor: Ahmet Akkok, Istanbul (TR)

(21) Appl. No.: 13/691,802

(22) Filed: Dec. 2, 2012

(51) Int. Cl. G06F 3/0488

(52) U.S. Cl. CPC G06F 3/04886
USPC 345/169

(57) ABSTRACT

A method of arranging keys of soft keyboard in specific, non rectangular shapes to provide wider width for keys in portrait mode and higher height for keys in landscape mode. Keys are shaped in the way that allows to be aligned in a complementary manner. For portrait mode keys are complementarily aligned on X axis and for landscape mode keys are complementarily aligned on Y axis.

### CROSS-REFERENCE TO RELATED APPLICATIONS

Not Applicable

### BACKGROUND OF THE INVENTION

Small computerized devices such as smart phones and tablets have become increasingly popular. These devices have touch sensitive screen for text and data entry. An image of a regular keyboard is displayed on the display, such that a user is able to select which key to “type” next by tapping on the image of the keyboard corresponding to the desired key. Such an image of a keyboard being displayed on the display of a device to provide for text and data entry by tapping the the image corresponding to keys of the keyboard, is known as a “soft” keyboard.

A disadvantage with such soft keyboards is, however, that the displayed keys of the keyboard on the display of the device are small, since the display of the device as well as the device itself are small. When QWERTY keyboard layout is used, the keyboard keys on the display got much smaller comparison to regular keyboards. This is the especially the case for devices with small display such as mobile phones.

Most of the touch screen devices are in rectangular shaped display. These devices can be held portrait as well as landscape, the graphical user interface changes accordingly. Soft keyboard layout changes based on how the device is held too, the width and height of the keys changes accordingly. When the device is held portrait, keys width are very narrow due to the limited display width however there is enough space for desired height. When the device is held landscape keys widths are adequate but key heights are very short due to the limited screen height. In addition in landscape mode there is a concern to leave space over for graphical user interface above the soft keyboard. The more space is left over for graphical interface above soft keyboard the shorter keys get.

Unlike regular keyboards it is not possible for fingers to feel borders between keys. This means that users are apt to tap incorrect keys, especially when “typing” quickly, and also that users are apt to type more slowly using soft keyboards, because of the dexterity required in order to achieve a high accuracy rate when typing. This limits the usefulness of these devices, since they cannot very conveniently be used for quick and/or large amounts of text and data entry. For this and other reasons, there is a need for the present invention.

### BRIEF SUMMARY OF THE INVENTION

The invention aims to improve typing experience in soft keyboards for touch screen devices. This is done by addressing narrow key problem when device is held portrait and by addressing short key problem when device is held landscape.

To overcome the narrow key problem in portrait mode, keys have different widths on the top and bottom edges, on the one edge wider width on the opposite edge narrower width. A key has wider width on the top edge and narrower width the bottom edge, the next key in the same row has narrower width on the top edge and wider width on the bottom edge as shown in FIG. 3, FIG. 4, FIG. 5, FIG. 6, FIG. 7 and FIG. 8.

To overcome the short key problem in landscape mode, keys have peak height, where the peak height can be on the right edge, left edge or in the middle of the key. Having such shapes gives the possibility to vertically align keys in a complementary manner as shown in FIG. 9, FIG. 10 and FIG. 11.

In the following description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the spirit or scope of the present invention. The following detailed description is, therefore, not to be taken in a limiting sense, and the scope of the present invention is defined only by the appended claims.

### BRIEF DESCRIPTION OF THE SEVERAL VIEWS OF THE DRAWING

FIG. 1: illustrates a soft keyboard with QWERTY layout in portrait mode on a portion of a touch-sensitive display device.

FIG. 2: illustrates number layout in a soft keyboard.

FIG. 3: illustrates a soft keyboard in portrait mode according to an embodiment of the invention where keys are in trapezoid shape and key representations letters are located at the same height along a row.

FIG. 4: illustrates a soft keyboard in portrait mode according to an embodiment of the invention where keys are in trapezoid shape and key representations letters are located at the mass center of the keys.

FIG. 5: illustrates a soft keyboard in portrait mode according to an embodiment of the invention where keys are in funnel shape.

FIG. 6: illustrates a soft keyboard in portrait mode according to an embodiment of the invention where keys are in triangular shape.

FIG. 7: illustrates a soft keyboard according to an embodiment of the invention in portrait mode where keys on the same row are shifted towards their wide edge in order to make better use of available space in Y axis.

FIG. 8: illustrates a soft keyboard in portrait mode according to an embodiment of the invention where soft keyboard is vertically symmetric.

FIG. 9: illustrates a soft keyboard in landscape mode according to an embodiment of the invention where peak height of the keys are in the middle of the key, which happens to have hexagon key shapes.

FIG. 10: illustrates a soft keyboard in landscape mode according to an embodiment of the invention where highest height of the keys are in the middle of the key, which happens to have octagon key shapes.

FIG. 11: illustrates a soft keyboard in landscape mode according to an embodiment of the invention where peak height of the keys are on the side of the keys.

### DETAILED DESCRIPTION OF THE INVENTION

The invention is not limited tablets and smart phones, embodiments of the invention are amenable to application to any device with soft keyboard, such as (but not limited to) devices that run the iOS operating system, devices that run Android operating system, devices that run Microsoft Windows 8 and Windows Phone 8 operating system, such as those available from RIM and Samsung as Microsoft, Nokia, and other vendors. Embodiments of the invention are also amenable to application to standard desktop computers, as well as other devices, such as devices commonly referred to as electronic books, or e-books.

Tablets and phones have touch-sensitive display, and therefore allows for output to be displayed thereon, as well as input to be entered thereon.

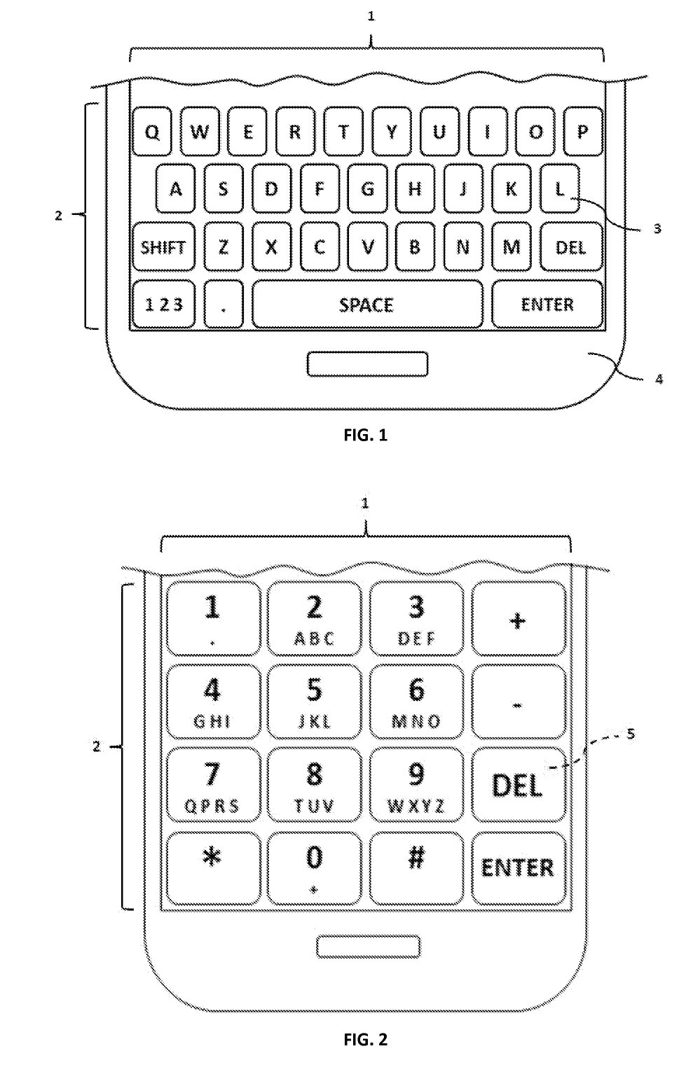

Referring next to FIG. 1, a diagram of a soft keyboard in conjunction with which embodiments of the invention may be practiced is shown. The display area 1, 2 is one part of a display of a device 4. The display area 1, 2 to accomodate the soft keyboard. The soft keyboard is an image of a real keyboard displayed on the display. Because it is not an actual, physical keyboard, the keyboard is referred to as a “soft” keyboard. “Typing” on the soft keyboard means tapping on the parts of the display on which the desired keys of the keyboard are displayed, with a finger or other implement, to cause the device to recognize that inputs have been made.

Most commonly used keyboard layout is QWERTY layout. FIG. 1 illustrates a compact form of QWERTY layout soft keyboard sample. There are more than thirty keys in four rows present in most compact form of English QWERTY layout. There are up to ten keys in one row, there are even more keys in an row in some languages' QWERTY layout.

Most of the touch screen devices are in rectangular shape. If the device's aspect ratio is 2:3, device's height is 50% greater than device's width in portrait mode. This means key widths are 50% wider when device is held landscape as opposed to portrait. In most soft keyboards key heights are shortened in landscape mode comparison to portrait mode in order to leave some space over above the soft keyboard for graphical user interface.

In the portrait mode the keys width are narrow and in landscape mode either keys height are short or there is too small space left over for display above the soft keyboard. Thus, individual keys on the soft keyboard are quite narrow in portrait mode and individual keys are short in landscape mode, making for inconvenient typing on the keyboard. Users are apt to tap the incorrect key when attempting to type a desired key sequence, as has been described in the background section. Embodiments of the invention attempt to overcome this disadvantage of small devices, such as mobile phones.

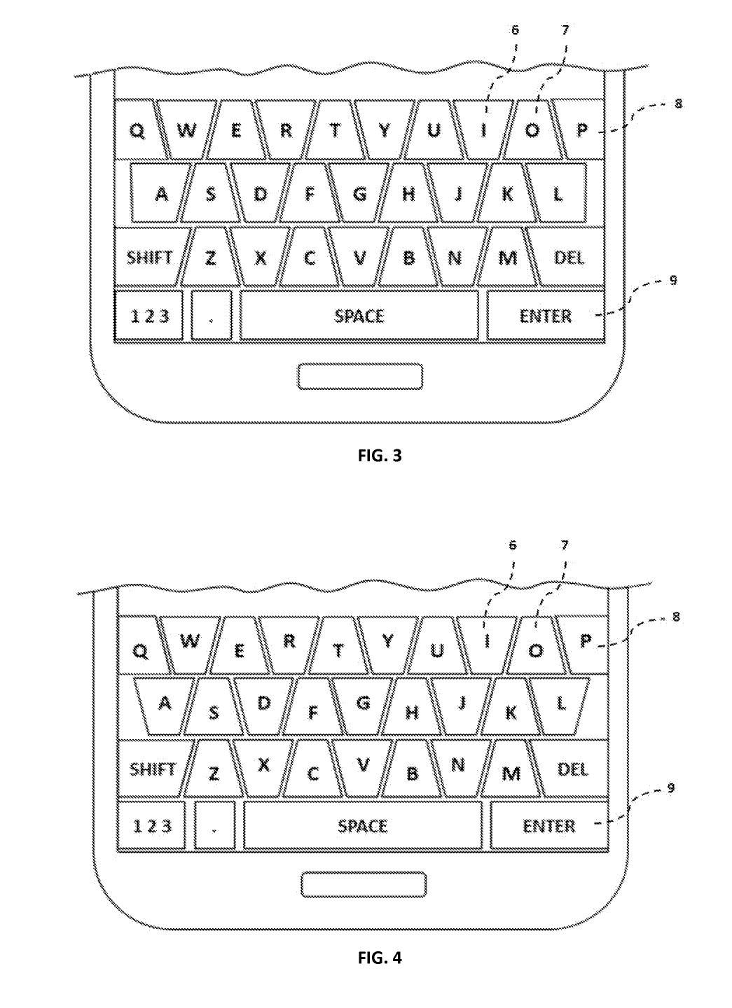

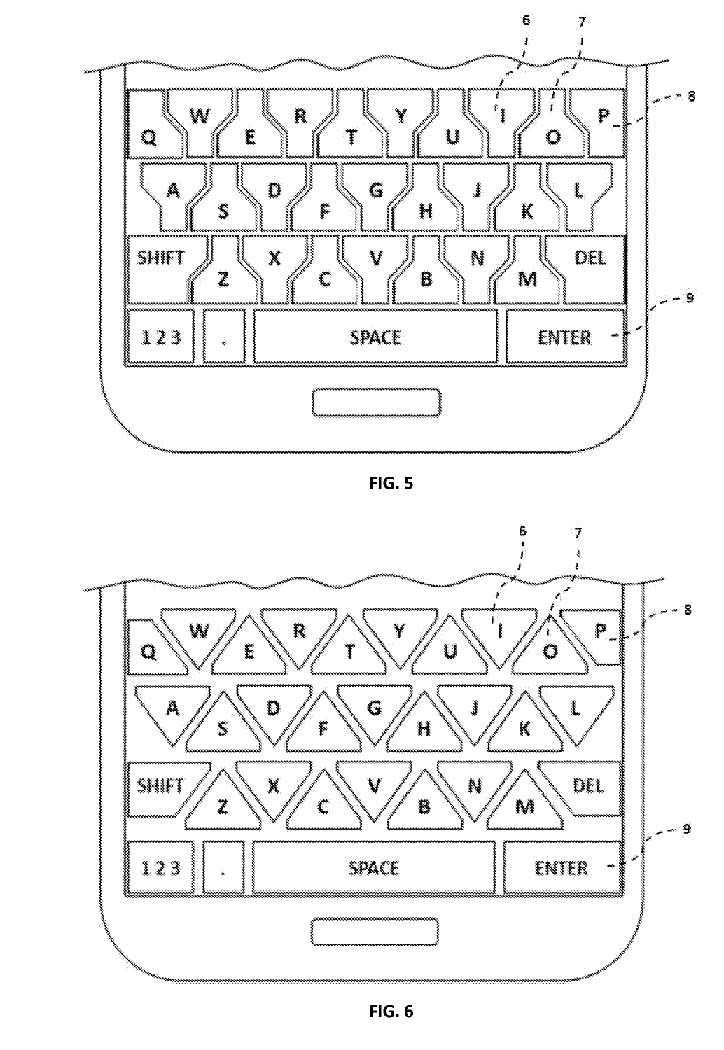

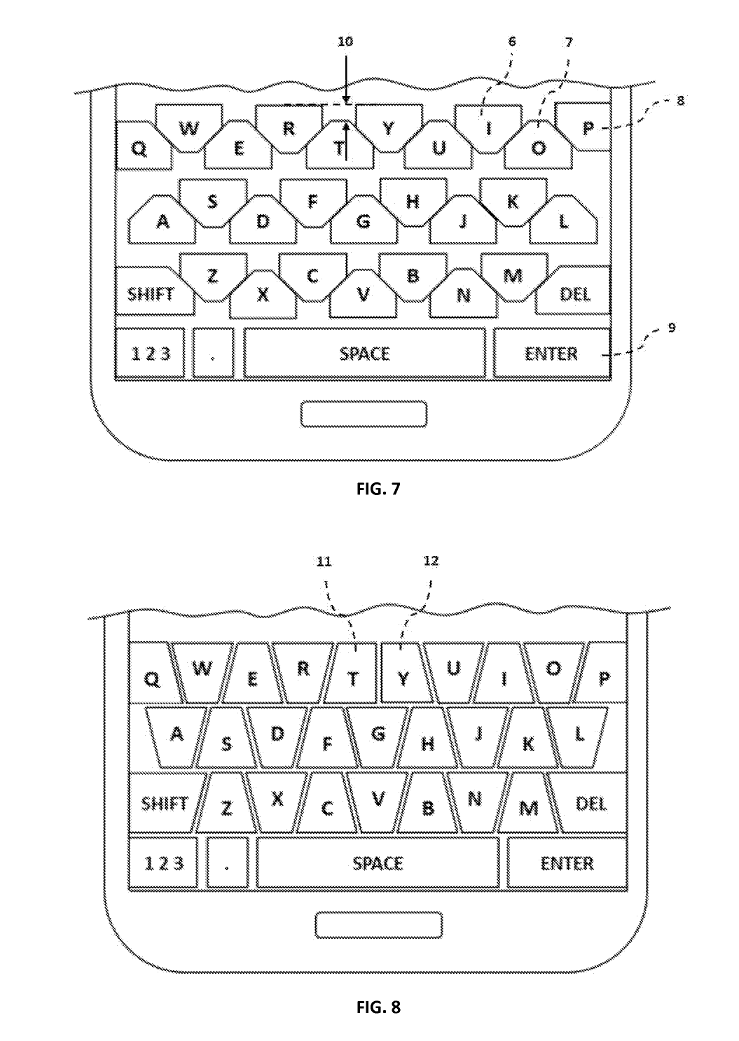

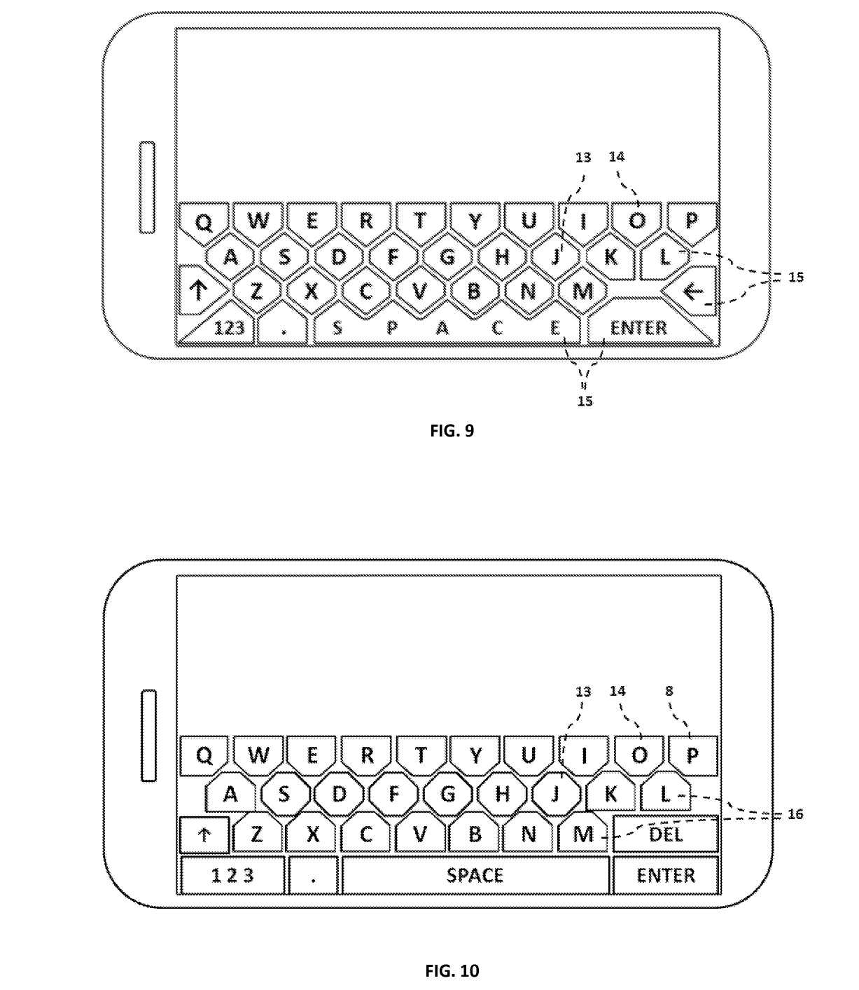

To overcome the narrow key problem on the portrait mode, the present invention shapes the keys in a non-rectangle form where key width is wider on the either bottom or top edge and narrower width on the opposite edge. This way keys have different widths on the top or bottom edges. The keys in the same row share the available space, in the way a key 6 has wider width on the top edge and narrower width the bottom edge and the next key 7 has narrower width on the top edge and wider width on the bottom edge. Keys are horizontally aligned in a complimentary manner as shown in FIG. 3, FIG. 4, FIG. 5, FIG. 6, FIG. 7 and FIG. 8.

When keys are shaped as described above, it requires dexterity to touch the narrow part of the keys but it becomes easier to touch the wide part of the key comparison to rectangular shaped keys 3 in landscape mode. To increase the total area of the keys, the height of the keys can be easily extended since there is no space concern Y axis in portrait mode. As a result keys will have bigger area and wider width.

In portrait mode, the keys can even be shifted 10 towards their wide edge in order to make better use of available space in Y axis. This means there may be two baselines for horizontal key alignment in a row, a baseline for keys having wide width on the top edge and a baseline for keys having wide width on the bottom edge as shown in FIG. 7.

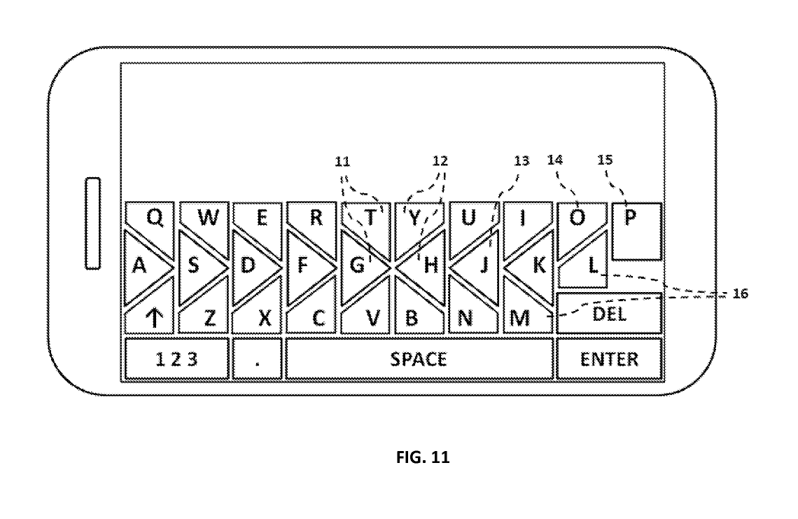

To overcome the short key problem in landscape mode, the present invention shapes the keys in a non-rectangle form where keys have a peak height, where the peak height can be on the right edge, left edge or somewhere between right and the left edges. Having such key shapes 13 gives the possibility to vertically align keys in a complementary manner as shown in FIG. 9, FIG. 10 and FIG. 11.

When keys are shaped as described above, it requires dexterity to touch the short part of the keys but it becomes easier to touch the tall part of the keys comparison to rectangular shaped keys 3 in landscape mode.

In embodiment of the invention, in portrait mode the shapes of the keys are formed in order to have different widths on the top and the bottom edges of the keys, where keys in the same row located in a complementary manner as shown in FIG. 3, FIG. 4, FIG. 5, FIG. 6, FIG. 7 and FIG. 8. Soft keyboards with any shape complying with this given description is an embodiment of this invention.

In embodiment of the invention, in landscape mode the shapes of the keys are formed in order to have peak height, where peak height could be anywhere of the key; on the left side, right side or some where in between. Eventually the keys should be able to vertically aligned in a complementary manner as shown in FIG. 9, FIG. 10 and FIG. 11. Soft keyboards with any shape complying with this given description is an embodiment of this invention.

In embodiment of the invention, character representation of keys can be located at the same height along a row regardless the shape of key as shown in FIG. 3, or they can be located at the center of mass of the keys as shown in FIG. 4, the invention itself is not limited to this specific manner of positioning letter representations keys.

In embodiment of the invention, the solution for narrow key problem in portrait mode and short key problem in landscape mode can be applied to all keys of the soft keyboard as well as to some of the keys or some rows 9 of the soft keyboard as shown FIG. 3, FIG. 4, FIG. 5, FIG. 6 and FIG. 7.

In embodiment of the invention, the solutions of narrow key problem in portrait mode and short key problem in landscape mode are not bind together, they can be used together or independently.

In embodiment of the invention, the solutions of narrow key problem in the portrait mode and short key problem in landscape mode can be used in QWERTY layout, DVORAK layout, number layout or any other keyboard layout, the invention itself is not limited to these specific manner of keyboard layouts.

In embodiment of the invention, the keys 8 to the left or right border of the display can have different shape than the others to make better use of available space as shown in FIG. 5, FIG. 6, FIG. 7 and FIG. 10.

In embodiment of the invention, keys 11, 12 in the middle of a row can have different shape in order to provide vertical symmetry to the soft keyboard as shown in FIG. 8 and FIG. 11.

In embodiment of the invention, the keys 14 on the top row of the soft keyboard in landscape mode can have a different shape with flat top edge to make better use of available space as shown FIG. 9, FIG. 10 and FIG. 11.

In embodiment of the invention, the keys 15 with one or more absent surrounding key can have a free form shape to make better use of available space as shown in FIG. 9 and FIG. 11. These shapes might not comply with the given shape definitions for portrait mode and landscape mode.

In embodiment of the invention, the keys 16 above a rectangle key or above the bottom border of device display can have a different shape with flat bottom edge to make better use of available space as shown in FIG. 10 and FIG. 11.

In embodiment of the invention, the display area 1, 2 to accommodate soft keyboard may not always full of keys, a key more keys can be spared and the left space from these keys can be partially or completely filled up by surrounding keys 15 as shown in FIG. 11.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. Therefore, it is manifestly intended that this invention be limited only by the following claims and equivalents thereof.

I claim:

1. In a computer system having a soft keyboard a method of providing keys to a user for data input, comprising shaping keys in a non-rectangle form to provide wider width in portrait mode and to provide higher height in landscape mode wherein key shapes allow to be complementarily aligned; in portrait mode keys are shaped with wider width on the either bottom or top edge and narrower width on the opposite edge; in landscape mode keys are shaped that has a peak height either on one side or in the middle of the keys.

2. The method of claim 1, wherein shaping keys in a non-rectangle form to provide wider width in portrait mode and to provide higher height in landscape mode compromises locating character representation of keys on mass center of the keys.

3. The method of claim 1, wherein shaping keys in a non-rectangle form to provide wider width in portrait mode and to provide higher height in landscape mode compromises locating character representation of keys at the same height along a row.

4. The method of claim 1, wherein shaping keys in a non-rectangle form to provide wider width in portrait mode and to provide higher height in landscape mode compromises utilizing solutions for portrait mode and landscape mode independently.

5. The method of claim 1, wherein shaping keys in a non-rectangle form to provide wider width in portrait mode and to provide higher height in landscape mode compromises utilizing solution for all keys of the soft keyboard as well as to some keys or some rows of the soft keyboard.

6. The method of claim 1, wherein shaping keys in a non-rectangle form to provide wider width in portrait mode and to provide higher height in landscape mode compromises utilizing solution for any keyboard layout.

7. The method of claim 1, wherein in portrait mode keys are shaped with wider width on the either bottom or top edge and narrower width on the opposite edge compromises shifting keys towards their wide edge.

8. The method of claim 1, wherein key shapes allow to be complementarily aligned compromises shaping keys differently with flat bottom edge that are above a rectangle key or above the bottom border of device display.

9. The method of claim 1, wherein key shapes allow to be complementarily aligned compromises shaping keys differently that have one or more absent surrounding key.

10. The method of claim 1, wherein key shapes allow to be complementarily aligned compromises shaping keys on the top row of the keyboard differently with flat top edge.

11. The method of claim 1, wherein key shapes allow to be complementarily aligned compromises shaping keys in the middle of a row differently to bring in vertical symmetry to the row.

12. The method of claim 1, wherein key shapes allow to be complementarily aligned compromises shaping keys on the left and right display border differently.

13. The method of claim 1, wherein in portrait mode keys are shaped with wider width on the either bottom or top edge and narrower width on the opposite edge; compromises utilizing larger area towards the top of device display in portrait mode comparison to soft keyboards with rectangular shaped keys.

14. The method of claim 1, wherein key shapes allow to be complementarily aligned compromises leaving a space out by sparing a key or more and partially fill up the left over space by extending surrounding keys.

15. The method of claim 1, wherein key shapes allow to be complementarily aligned compromises leaving a space out by sparing a key or more and fill up the left over space by extending surrounding keys.
